(19) United States
(12) Patent Application Publication
(10) Pub. No.: US 2007/0241525 A1
(43) Pub. Date: Oct. 18, 2007

(54) STROLLER

(75) Inventor: John Gert Til Van Dijk, Helmond (NL)

Correspondence Address: BARNES & THORNBURG LLP, 11 SOUTH MERIDIAN, INDIANAPOLIS, IN, 46204, US

(73) Assignee: Maxi Miliaan B.V., Helmond (NL)

(21) Appl. No.: 11/696,590

(22) Filed: Apr. 4, 2007

(30) Foreign Application Priority Data
Apr. 5, 2006 (NL) 1031517

(51) Int. Cl. B62B 7/00

(52) U.S. Cl. 280/47.38

(57) ABSTRACT

The stroller comprises a frame and wheels supporting the frame. The stroller can at least be wheeled over a ground surface in a horizontal direction of movement, wherein at least one wheel is movable in a vertical direction with respect to the frame. At least one wheel is simultaneously movable in a vertical direction and in a horizontal direction parallel to the direction of movement with respect to the frame.

The invention relates to a stroller comprising a frame and wheels supporting the frame, which stroller can at least be wheeled over a ground surface in a horizontal direction of movement, wherein at least one wheel is movable in a vertical direction with respect to the frame.

With such a stroller, which is known from DE-U1-20.2004.012.083, the front wheels, seen in the direction of movement of the stroller, are interconnected by a rod which is pivotable about a horizontal pivot axis extending parallel to the direction of movement. Forces will be exerted on the wheels when driving on an uneven ground surface, as a result of which the rod will pivot about the pivot axis, so that the two wheels can maintain contact with the uneven ground surface.

It has been found, however, that when a wheel comes into contact with an obstacle present on the ground surface as a result of the movement of the stroller in the direction of movement, a horizontal force is exerted on the stroller, which force is to be converted into a vertical force in the stroller for pivoting the rod about the horizontally extending pivot axis. Such a transmission of forces leads to undesirable impact forces being exerted on the stroller, which a child seated in the stroller will find unpleasant.

The object of the invention is to provide a stroller in which an improved transmission of the forces exerted on the stroller is realised.

This object is accomplished with the stroller according to the invention in that at least one wheel is simultaneously movable in a vertical direction and in a horizontal direction parallel to the direction of movement with respect to the frame.

Since the wheel is movable not only in vertical direction but also in horizontal direction, a better transmission of forces is obtained when a wheel hits an obstacle present on the ground surface.

One embodiment of the stroller according to the invention is characterised in that the wheel is simultaneously movable in a vertical direction away from the ground surface and a horizontal direction opposite to the direction of movement.

As soon as the wheel comes into contact with an obstacle present on the ground surface, a force will be exerted on the wheel in a horizontal direction opposite to the direction of movement. This causes the wheel to move in that direction, but the wheel will simultaneously be moved in a vertical direction away from the ground surface, as a result of which the wheel is moved over said obstacle. In this way an advantageous transmission of forces is obtained.

Another embodiment of the stroller according to the invention is characterised in that the wheel is movable against spring force.

As a result, the wheel will be moved against spring force with respect to the frame upon hitting an obstacle, and subsequently the wheel will be returned to its original starting position under the influence of spring force.

Yet another embodiment of the stroller according to the invention is characterised in that at least two wheels are interconnected by a connecting element, which connecting element is pivotable with respect to the frame about a pivot axis that extends at an angle to the horizontal, which wheels are movable in opposite vertical directions and in opposite horizontal directions upon pivoting of the connecting element.

This has a positive effect on the driving characteristics of the stroller, wherein a first wheel that comes into contact with an obstacle is preferably moved in a horizontal direction opposite to the direction of movement and a vertical direction away from the ground surface, whilst the other, second wheel is moved horizontally in the direction of movement with respect to the frame and is pressed more firmly against the ground surface. As a result, the first wheel can readily move over the obstacle.

Yet another embodiment of the stroller according to the invention is characterised in that the pivot axis includes an angle of at least 20 degrees with the horizontal.

When such an angle is used, an advantageous relation is obtained between the horizontal movement and the vertical movement of each wheel.

Yet another embodiment of the stroller according to the invention is characterised in that the pivot axis includes an acute angle with the horizontal, seen in the direction of movement.

When such an acute at angle is used, one wheel will be moved in a vertical direction away from the ground surface and a horizontal direction opposite to the direction of movement, whilst the other wheel will be moved in the opposite direction. In this way an efficient transmission of forces is obtained.

Yet another embodiment of the stroller according to the invention is characterised in that the connecting element is pivotally connected to the frame against spring force.

As a result of the spring force, the starting position of the connecting element will be such that the wheels are identically oriented with respect to the frame. Only in the case of a force being exerted on one of the wheels will the connecting element pivot against said spring force. Once said force is released, the connecting element will pivot back to the starting position under the influence of the spring force.

Another embodiment of the stroller according to the invention is characterised in that the connecting element is detachably connected to the frame.

In this way the connecting element and the wheels connected thereto can be readily detached from the frame, after which the frame is preferably collapsible, so that the frame and the connecting element that has been detached therefrom can easily be transported, for example in a car.

Yet another embodiment of the stroller according to the invention is characterised in that the wheel is pivotable with respect to the connecting element about a substantially vertically extending pivot axis.

As a result, turning the stroller about a vertically extending axis when going round a bend is moreover comparatively easy.

Yet another embodiment of the stroller according to the invention is characterised in that the wheels connected to the connecting element are the front wheels of the stroller, seen in the direction of movement.

The front wheels of the stroller are the wheels that first come into contact with an obstacle present on the ground surface. Since said wheels are connected to the connecting element, an efficient transmission of the forces being exerted on the stroller is obtained. It is also possible, of course, to provide the rear wheels of the stroller, seen in the direction of movement, with such a connecting element or to provide both the front wheels and the rear wheels with a connecting element.

Another embodiment of the stroller according to the invention is characterised in that the connecting element comprises an unround shaft which is pivotally journalled in an unround opening in a material that is elastically deformable against spring force.

As a result, the connecting element is spring-connected to the frame in a relatively simple manner.

The elastically deformable material preferably comprises rubber.

The connecting element may also be spring-connected to the frame by means of a leaf spring or a spiral spring. Such springs, too, can be realised in a relatively simple manner.

The invention will now be explained in more detail with reference to the drawings, in which:

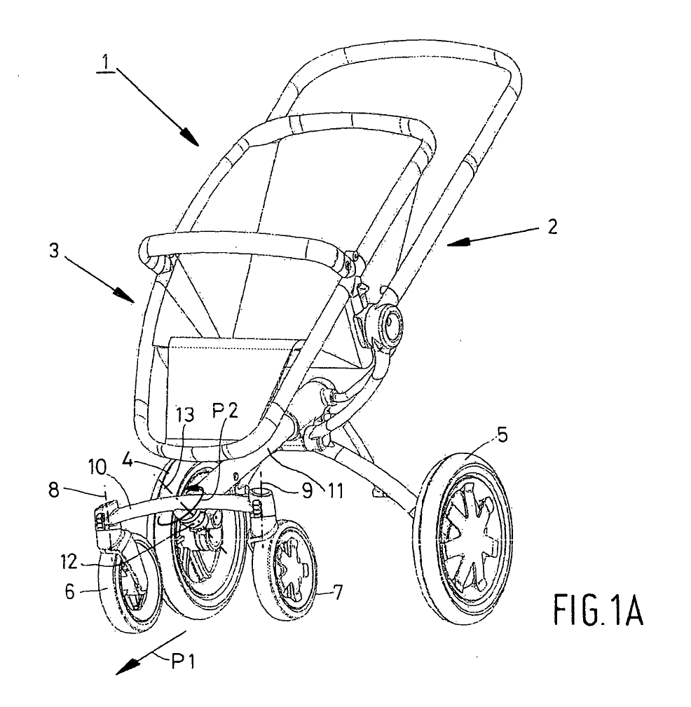

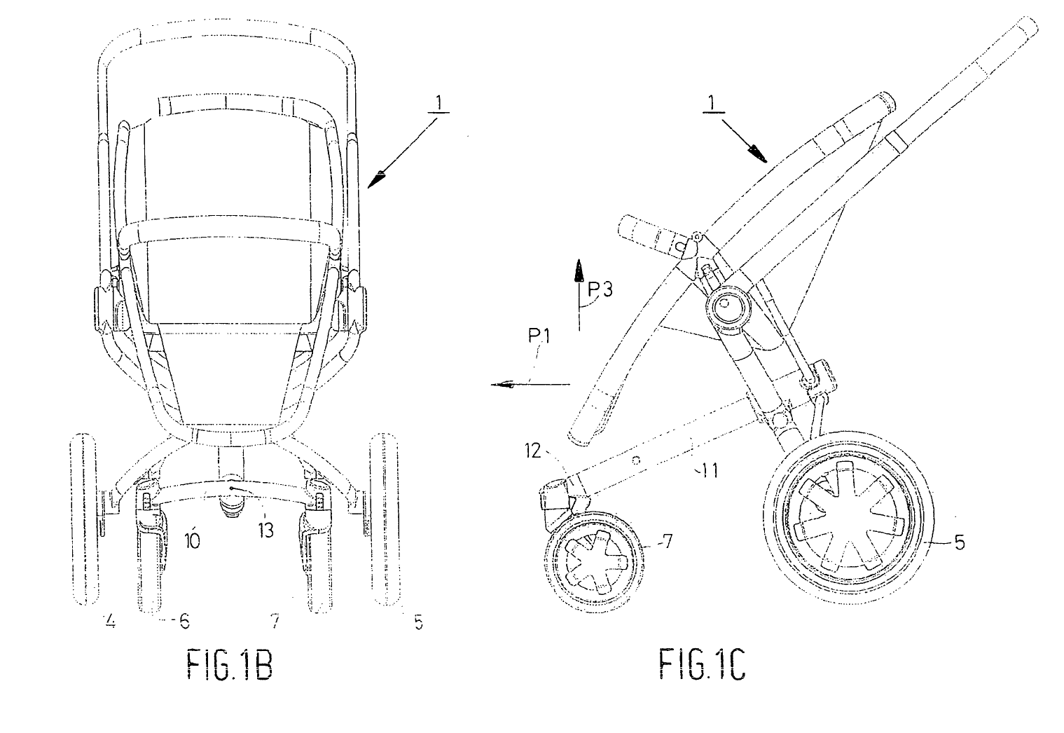

FIGS. 1A-1C are a perspective view, a front view and a side view, respectively, of a stroller according to the invention;

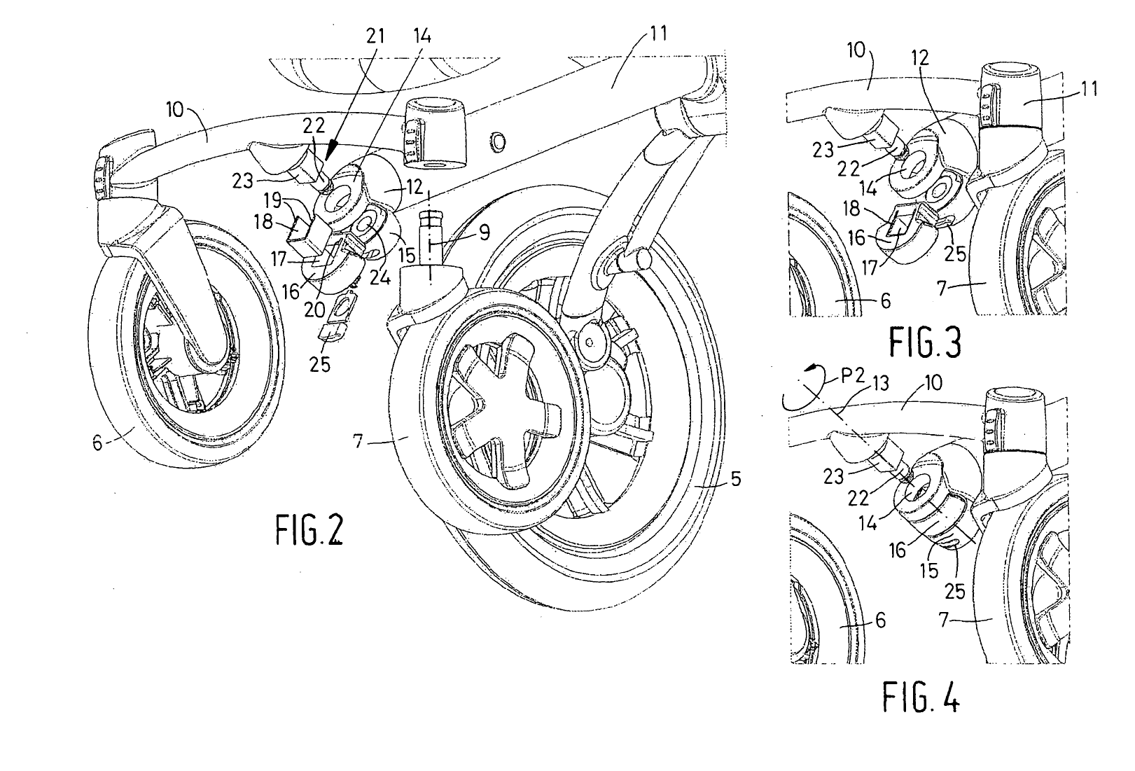

FIG. 2 is a perspective, exploded view of a part of the stroller shown in FIGS. 1A-1C;

FIG. 3 shows a detail of the perspective view of FIG. 2;

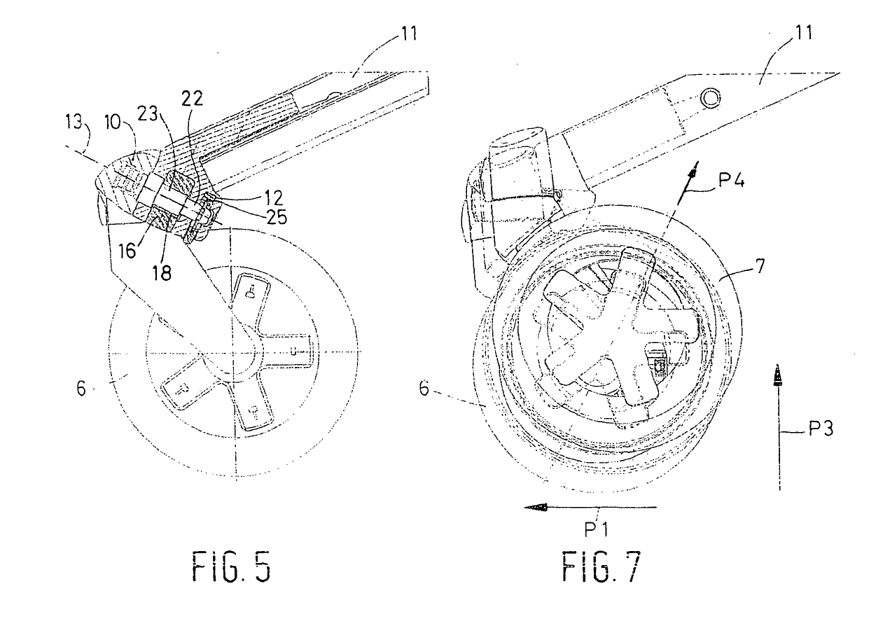

FIG. 4 is a perspective view corresponding to the detail view of FIG. 3, in which a few components are shown in assembled condition;

FIG. 5 is a sectional side view of a part of the stroller shown in FIG. 1C;

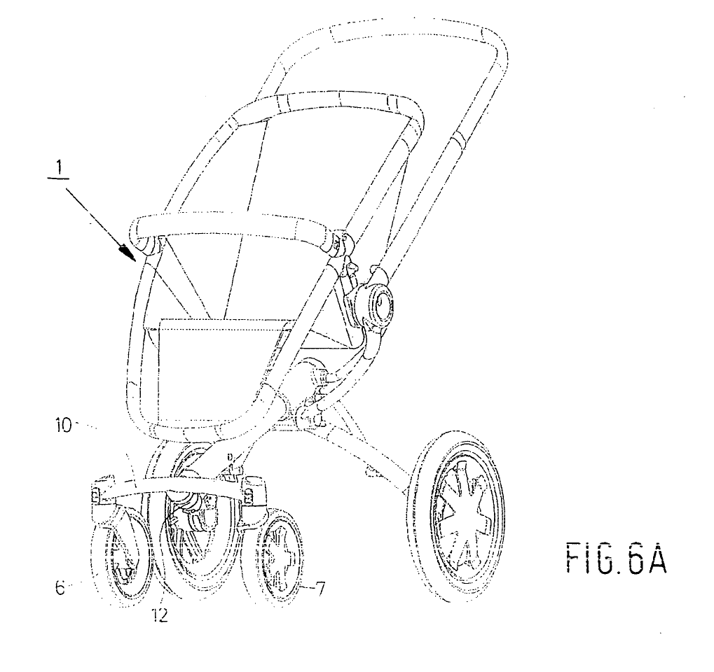

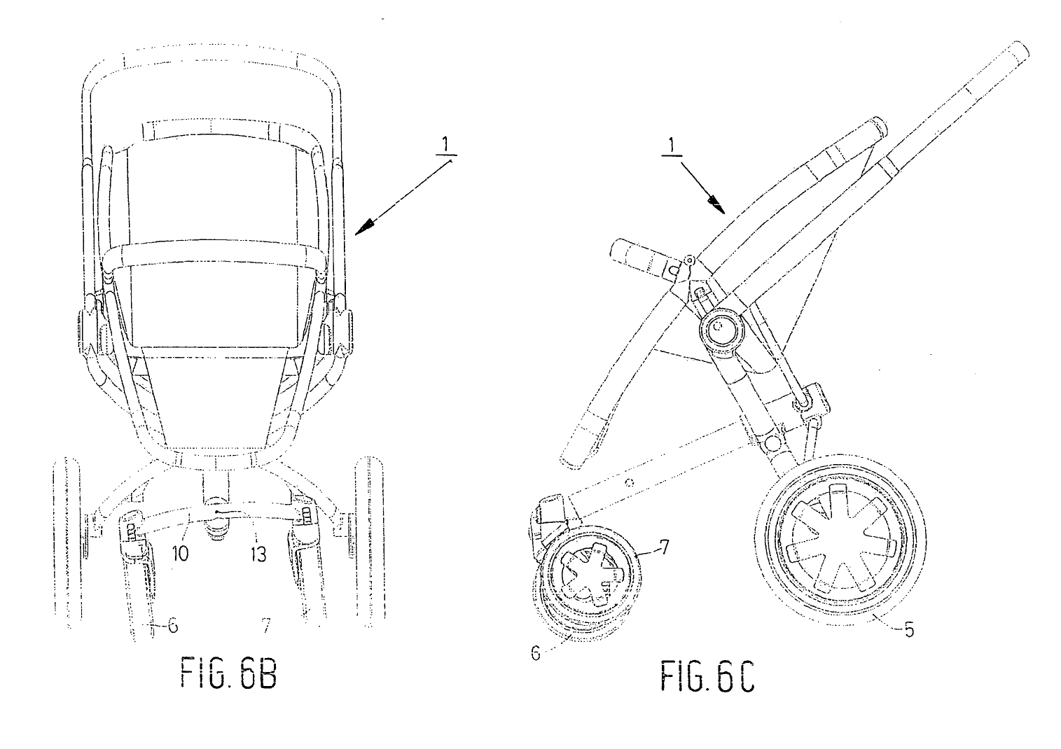

FIGS. 6A-6C are a perspective view, a front view and a side view, respectively, of the stroller shown in FIGS. 1A-1C, in which the front wheels have been moved with respect to the frame;

FIG. 7 shows a part of the side view of FIG. 6C;

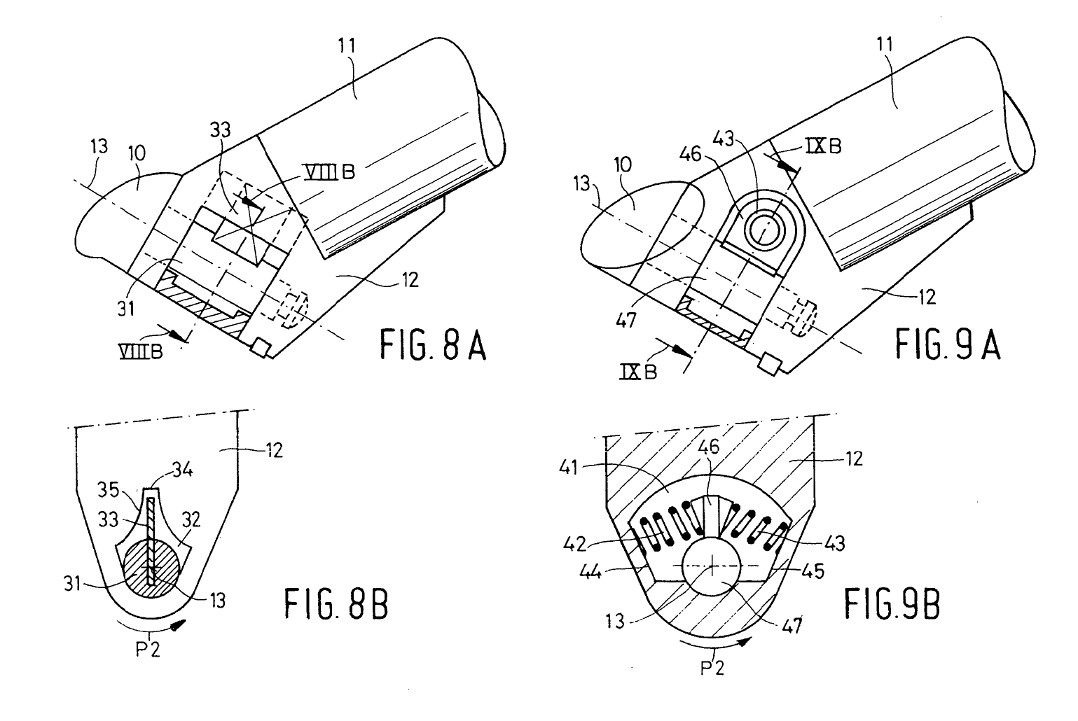

FIGS. 8A and 8B are a sectional side view and a front view in the direction indicated by the arrows VIII-VIII of an alternative embodiment of the spring-mounted construction shown in FIGS. 2-4;

FIGS. 9A and 9B are a sectional side view and a front view in the direction indicated by the arrows IX-IX of an alternative embodiment of the spring-mounted construction shown in FIGS. 2-4.

Like parts are indicated by the same numerals in the figures.

FIGS. 1A-1C are a perspective view, a front view and a side view, respectively, of a stroller 1 according to the invention, which comprises a frame 2, a seat 3 supported by the frame 2 and detachably connected thereto, a pair of rear wheels 4, 5 and a pair of front wheels 6, 7. The rear wheels 4, 5 and the front wheels 6, 7 support the frame 2. The front wheels 6, 7 are pivotally connected about vertically extending pivot axes 8, 9 to a rod 10, which extends substantially transversely to the direction of movement of the stroller indicated by the arrow P1. The rod 10 forms a connecting element for interconnecting the front wheels 6, 7. The frame 2 comprises a section 11 extending in the direction of movement indicated by the arrow P1, which section is provided with a connecting element 12 at an end located near the front wheels 6, 7, to which connecting element 12 the rod 10 can be detachably connected. The rod 10 is pivotable about a pivot axis 13 with respect to the connecting element 12 in the direction indicated by the arrow P2 and in the opposite direction. Pivoting of the rod 10 about the pivot axis 13 causes the wheels 6, 7 to be moved with respect to the frame 2 in the horizontal direction indicated by the arrow P2 and in the opposite direction and in the vertical direction indicated by the arrow P3 and in the opposite direction.

FIGS. 2-5 show an embodiment of the connection of the rod 10 to the connecting element 12 of a stroller 1 according to the invention. The connecting element 12 comprises two spaced-apart annular elements 14, 15 and a rubber block 16 that can be positioned between said annular elements 14, 15. The rubber block 16 is provided with a square passage 17, in which a U-shaped metal section 18 is positioned. Legs 19 of the U-shaped section 18 extend into gaps 20 that connect to the square passage 17. As a result, the U-shaped section 18 is adequately locked in position in the rubber element 16. The rod 10 is provided with a pin 21 extending parallel to the pivot axis 13, which pin comprises a circular cylindrical part 22 and a square part 23 located between the circular cylindrical part 22 and the rod. The dimensions of the square part 23 are such that it fits in the square passage 17 defined by the rubber element 16 and the U-shaped section 18. After the element 16 has been positioned between the annular elements 14, 15 (see FIG. 4), the pin 21 can be inserted into the annular element 14 until the part 22 is positioned in the opening 24 in the annular part 15 and the square part 23 is positioned in the square passage 17. The pin 21 is retained in the position thus obtained by means of a locking pawl 25. The circular cylindrical part 22 can pivot in the opening 24 in the direction indicated by the arrow P2 and in the opposite direction. During said pivoting, the square part 22 exerts a force on the metal U-shaped part 18, resulting in elastic deformation of the rubber element 16.

FIGS. 6A-6C and FIG. 7 show a situation in which the front wheel 7 comes into contact with an obstacle present on a ground surface, as a result of which a force is exerted on the front wheel 7 in a direction opposite to the direction indicated by the arrow P1 and in the direction indicated by the arrow P3. The resultant of said force extends in the direction indicated by the arrow P4 (see FIG. 7). As a result of said force P4, the wheel 7 is moved in said direction, whilst the rod 10 pivots in the direction indicated by the arrow P2 and the wheel 6 is moved in a direction opposite to the direction of movement of the wheel 7. The wheel that comes into contact with an obstacle is moved in a direction away from the ground surface and in a direction opposite to the direction of movement, whilst the other wheel is moved in the direction of movement and in a direction towards the ground surface. In this way the stroller is moved over the obstacle in a simple manner.

FIGS. 8A hand 8B show another embodiment of a spring connection of the rod 3 to the connecting element 12. The rod 3 is provided with a pin 31, which extends through an opening 32 in the connecting element 12. The pin 31 is provided with a leaf spring 33 extending transversely to the pin 31, which leaf spring is positioned in a chamber 34 of the opening 32 with a side remote from the pin 31. The leaf spring 33 will deform and slide along a wall 35 of the openings 32 when the rod 10 and the pin 31 connected thereto pivot in the direction indicated by the arrow P2 or in the opposite direction. Once the forces being exerted on the stroller and 1 are released, the rod 10 will return to the position shown in FIG. 8B under the influence of the spring force of the leaf spring 33.

FIGS. 9A and 9B show yet another embodiment of a spring connection between the rod 10 and the connecting element 12. The connecting element 12 comprises a chamber 41, in which two spiral springs 42, 43 are positioned. The spiral springs 42, 43 abut against the walls 44, 45 of the chamber 41 with one end and against a plate 46 with an end remote from the walls 44, 45. The plate 46 forms part of a pin 47 that is connected to the rod 10. Pivoting of the rod 10 and the pin 47 connected thereto in the direction indicated by the arrow P2 or in the opposite direction results in compression of one spiral spring 43, 44 and extension of the other spiral spring 43, 44. As soon as the forces being exerted on the two front wheels 6, 7 are in balance again, the rod 10 will return to the starting position shown in FIGS. 1A-1C under the influence of the spring force of the springs 43, 43.

Is also possible to configure the wheels 6, 7 to be movable independently of each other.

1. A stroller comprising a frame and wheels supporting the frame, which stroller can at least be wheeled over a ground surface in a horizontal direction of movement, wherein at least one wheel is movable in a vertical direction with respect to the frame, characterised in that at least one wheel is simultaneously movable in a vertical direction and in a horizontal direction parallel to the direction of movement with respect to the frame.

2. A stroller according to claim 1, characterised in that the wheel is simultaneously movable in a vertical direction away from the ground surface and a horizontal direction opposite to the direction of movement.

3. A stroller according to claim 1 or 2, characterised in that the wheel is movable against spring force.

4. A stroller according to any one of the preceding claims, characterised in that at least two wheels are interconnected by a connecting element, which connecting element is pivotable with respect to the frame about a pivot axis that extends at an angle to the horizontal, which wheels are movable in opposite vertical directions and in opposite horizontal directions upon pivoting of the connecting element.

5. A stroller according to claim 4, characterised in that the pivot axis includes an angle of at least 20 degrees with the horizontal.

6. A stroller according to claim 4 or 5, characterised in that the pivot axis includes an acute angle with the horizontal, seen in the direction of movement.

7. A stroller according to any one of the preceding claims 4-6, characterised in that the connecting element is pivotally connected to the frame against spring force.

8. A stroller according to any one of the preceding claims 4-7, characterised in that the connecting element is detachably connected to the frame.

9. A stroller according to any one of the preceding claims 4-8, characterised in that the wheel is pivotable with respect to the connecting element about a substantially vertically extending pivot axis.

10. A stroller according to any one of the preceding claims 4-9, characterised in that the wheels connected to the connecting element are the front wheels of the stroller, seen in the direction of movement.

11. A stroller according to claim 7, characterised in that the connecting element comprises an unround shaft which is pivotally journalled in an unround opening in a material that is elastically deformable against spring force.

12. A stroller according to claim 11, characterised in that the elastically deformable material comprises rubber.

13. A stroller according to claim 7, characterised in that at least a leaf spring or a spiral spring is provided between the connecting element and the frame.
